(19) United States
(12) Patent Application Publication
(10) Pub. No.: US 2015/0346234 A1
(43) Pub. Date: Dec. 3, 2015

(54) DOWNHOLE ROTATIONAL SPEED MEASUREMENT SYSTEM AND METHOD

(71) Applicant: Smith International, Inc., Houston, TX (US)

(72) Inventors: Michael Campbell, Alberta (CA); Catalin Badea, Calgary (CA); Jaroslav Dobos, Calgary (CA); Barry Buternowsky, Calagary (CA); Mihai Silviu Calin, Calgary (CA); Fuchun Liu, Calagary (CA); Chen Chen, New Haven, CT (US)

(21) Appl. No.: 14/727,891

(22) Filed: Jun. 2, 2015

Related U.S. Application Data
(60) Provisional application No. 62/006,456, filed on Jun. 2, 2014.
(60) Provisional application No. 62/017,035, filed on Jun. 25, 2014.

(51) Int. Cl. G01P 3/487; E21B 47/12; G01D 5/14

(52) U.S. Cl. CPC G01P 3/487; G01D 5/142; E21B 47/12

(57) ABSTRACT

A rotational speed measurement system may include a rotational speed measuring device for measuring a rotational speed of a motor or component thereof. The downhole rotational speed measuring device may include a magnet and a magnetic sensor. A telescoping unit may position the magnetic sensor into sensing proximity of the magnet. A method for measuring downhole rotational speed may include coupling a rotational speed measuring device to a measurement assembly and a motor. The rotational speed measuring device may include a magnet and a magnetic sensor. The position of the magnetic sensor, the magnet, or both, may be adjusted with a telescoping unit to place the magnetic sensor into sensing proximity of the magnet.

### CROSS-REFERENCE TO RELATED APPLICATIONS

This application claims the benefit of, and priority to, U.S. Patent Application Ser. No. 62/006,456, filed Jun. 2, 2014, and to U.S. Patent Application Ser. No. 62/017,035, filed Jun. 25, 2014, which applications are expressly incorporated herein by this reference.

### BACKGROUND

A well may be drilled into the ground for a variety of extraction or exploratory purposes. For example, a wellbore, also known as a borehole, may be formed to allow liquids such as water or petroleum, or gases such as natural gas, to be extracted from the ground. A wellbore may also be formed to obtain information about the physical properties of soil and rock in a particular location, or to explore for natural resources, such as water, gas or oil, minerals, or ore deposits.

Various systems have been used to drill or otherwise create wellbores, which may vary in depth from a few feet to thousands of feet or even miles. Mechanical drilling systems are often used to create deep or long wellbores by drilling. A drill system may include a drill string connecting a drill bit at the bottom of a wellbore to a rotary table or top drive that may be located at the surface. The rotary table or top drive rotates the drill string, which causes the drill bit to rotate and bore into the ground. According to another drilling system, a downhole motor within a bottomhole assembly (BHA) may be used to power or spin a drill bit located at the lower end of a drill string. The downhole motor may be powered by a mud pump that pumps drilling mud or fluid down the drill string. The downhole motor may then convert the hydraulic energy of the flowing fluid to power used to rotate the drill bit at the lower end of the BHA.

### SUMMARY

According to some embodiments, a rotational speed measurement system may include a rotational speed measuring device for measuring a rotational speed of a motor or other component. The downhole rotational speed measuring device may include a magnet and a magnetic sensor. A telescoping unit may position the magnetic sensor within sensing proximity of the magnet.

A further rotational speed measurement system is provided in accordance with some embodiments of the present disclosure, and may include a rotational speed measuring device that measures a rotational speed of a motor. The rotational speed measuring device may include a magnet and a magnetic sensor, or a pressure pulse generator. A magnet may be coupled to a magnetic assembly, and the magnetic assembly may be coupled to a shaft of the motor. The magnetic sensor may be coupled to or included in an inside diameter of a measurement assembly. The measurement assembly may be arranged to receive the magnetic assembly. A pressure pulse generator may generate pressure pulses detected by a pressure pulse sensor, and which correspond to a rotational speed of the shaft of the motor.

A method for measuring downhole rotational speed of a downhole component is also provided in accordance with some embodiments of the present disclosure. According to at least one embodiment, the method may include coupling a rotational speed measuring device to a measurement assembly and a downhole component. The rotational speed measuring device may include a magnet and a magnetic sensor. The method for measuring downhole rotational speed may further include placing the magnetic sensor within sensing proximity of the magnet by using a telescoping unit to adjust a position of the magnetic sensor, the magnet, or both the magnetic sensor and the magnet.

This summary is provided to introduce some features and concepts that are further developed in the detailed description. Other aspects and features will be apparent from the following description and the appended claims. The various features described above, as well as other features, will be readily apparent to those skilled in the art upon reading the following detailed description, and by referring to the accompanying drawings. This summary is therefore not intended to identify key or essential features of the claimed subject matter, nor is it intended to be used as an aid in limiting the scope of the claims.

### BRIEF DESCRIPTION OF DRAWINGS

In order to describe various features and concepts of the present disclosure, a more particular description of certain subject matter will be rendered by reference to specific embodiments which are illustrated in the appended drawings. Understanding that these drawings depict just some example embodiments and are not to be considered to be limiting in scope, nor drawn to scale for each embodiment contemplated hereby, various embodiments will be described and explained with additional specificity and detail through the use of the accompanying drawings in which:

FIG. 1 is a schematic view illustrating a drilling system in accordance with embodiments disclosed herein;

FIGS. 2-1 and 2-2 are schematic cross-sectional views of a downhole tool or sensor string in accordance with embodiments disclosed herein;

FIG. 3 is a partial cross-sectional view of components of a downhole rotational speed measurement system in accordance with embodiments disclosed herein;

FIG. 4-1 is a perspective view of a magnetic finger in accordance with embodiments disclosed herein;

FIG. 4-2 is a cross-sectional view of the magnetic finger of FIG. 4-1;

FIG. 5 is a perspective view of a magnetic insert in accordance with embodiments disclosed herein;

FIG. 6-1 is a perspective view of a magnetic sensor housing in accordance with embodiments disclosed herein;

FIG. 6-2 is a cross-sectional view of the magnetic sensor housing of FIG. 6-1;

FIG. 7 is a cross-sectional view of a telescoping unit in accordance with embodiments disclosed herein;

FIG. 8 is a perspective, cross-sectional view of a portion of a telescoping unit in accordance with embodiments disclosed herein;

FIG. 9 is a partial cross-sectional view of components of a downhole rotational speed measurement system in accordance with another embodiment disclosed herein;

FIG. 10 schematically illustrates a drilling system with a rotational speed measurement system in accordance with an embodiment of the present disclosure;

FIG. 11 schematically illustrates a drilling system with a modular rotational speed measurement system and cross-over sub in accordance with an embodiment of the present disclosure; and

FIGS. 12-1 and 12-2 are schematic, cross-sectional views of a pressure pulse generator for measuring rotational speed, in accordance with embodiments disclosed herein.

### DETAILED DESCRIPTION

The following is directed to various embodiments of the disclosure. The embodiments disclosed should not be interpreted, or otherwise used, as limiting the scope of the disclosure, including the claims. In addition, those having ordinary skill in the art will appreciate that the following description has broad application, and the discussion of any embodiment is not intended to suggest that the scope of the disclosure, including the claims, is limited to that embodiment.

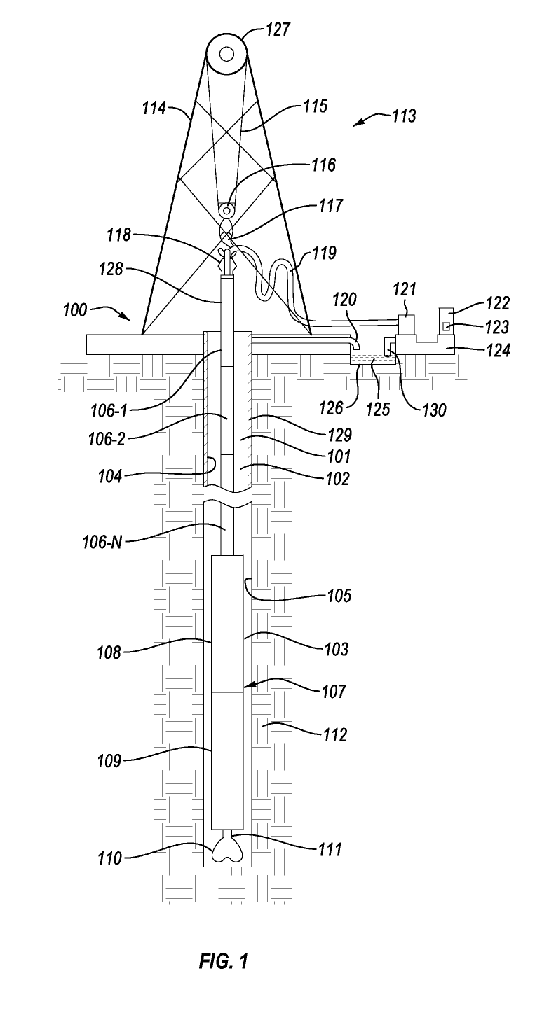

Referring to FIG. 1, a drilling system 100 may include an above-ground or at-ground portion 113 and a drill string 128 extending into a wellbore 101. In some embodiments, drill string 128 may be segmented and formed of multiple, discrete drill pipes 106-1, 106-2 . . . 106-N coupled together. Optionally, the lower of the drill pipes 106-N may be coupled to a bottomhole assembly 107. In some embodiments, drill pipes 106-1 . . . 106-N may be coupled together by being threadably connected to one another. For instance, the drill pipes 106-1 . . . 106-N may each include a threaded pin connection at one end and a threaded box connection at the other end. The threads of the box and pin connections may be configured to mate and engage each other. As a result, the threaded box connection of one of the drill pipes 106-1 . . . 106-N may engage and mate with a corresponding threaded pin connection of another one of the drill pipes 106-1 . . . 106-N. In other embodiments, the drill pipes 106-1 . . . 106-N may be coupled together in other manners (e.g., threaded couplings having two threaded box connections may couple a threaded pin connection of one of the drill pipes 106-1 . . . 106-N with a threaded pin connection of another one of the drill pipes 106-1 . . . 106-N). In still other embodiments, the drill pipes 106-1 . . . 106-N may be replaced by a continuous conduit or drill string such as coiled tubing.

Wellbore 101 may extend through a formation 112 and may include an upperhole portion 102 and a downhole portion 103. Upperhole portion 102 may have a casing 104 fixed on an upper wellbore wall 129, while a lower wellbore wall 105 of downhole portion 103 may remain uncased. Upperhole portion 102 may therefore also be referred to as a cased portion, and downhole portion 103 may be referred to as an uncased or openhole portion. In other embodiments, the full length of the wellbore 101 may be cased or uncased. In some embodiments, bottomhole assembly 107 may include a measurement assembly 108, motor 109, and drill bit 110. Drill bit 110 may be connected to motor 109 by a shaft 111. In some embodiments, the shaft 111 may be a drive shaft that is rotated by motor 109 and used to rotate drill bit 110. Measurement assembly 108 may be positioned above and coupled to a top portion of motor 109. In some embodiments, measurement assembly 108 may include a drill collar. In the discussion herein, the measurement assembly 108 should therefore be broadly construed to include a drill collar; however, the measurement assembly 108 is not limited to use with or as a drill collar. In other embodiments, for instance, the measurement assembly 108 may include a joint, a measurement sub, some other tool, or any combination of the foregoing.

The drilling system 100 may include a circulating pump 124 that takes suction through an intake pipe 130 contained in a mud reservoir 126, and drives mud 125 through a hose 119 to drill string 128, which may be suspended from a traveling block hook 117 by a swivel 118. A surge chamber 121 may be provided to smooth out or reduce pump discharge fluctuations. A lower traveling block 116, which may be suspended from a crown or upper block 127 at a top portion of a derrick 114, may be raised or lowered by a drilling line 115 to accommodate newly added sections of drill pipe 106-1 . . . 106-N, which are added to drill string 128 as the bottomhole assembly 107 extends deeper into formation 112.

Mud 125 may be circulated through the drilling system 100 by circulating pump 124, which may move the mud 125 through hose 119 and down drill string 128. Within the bottomhole assembly 107, the circulation of mud 125 may cause mud 125 to pass through measurement assembly 108 and into motor 109. Within motor 109, the flow of mud 125 may be used as a hydraulic energy source and may be converted to mechanical energy to power rotation of shaft 111, thereby causing drill bit 110 to rotate. During operation, motor 109 or measurement assembly 108 may be rotated relative to each other. Additionally, motor 109, measurement assembly 108, or both may be rotated relative to drill string 128 or drill pipe 106-1 . . . 106-N. A rotational speed measurement system as described herein may measure the rotational speed of the motor 109 relative to the measurement assembly 108 or vice versa, the rotational speed of the motor 109 relative to the drill string 128 or drill pipe 106-1 . . . 106-N or vice versa, or both. Through rotation of drill bit 110 and the application of weight-on-bit (e.g., through measurement assembly 108 and/or other components of the drilling system 100), drill bit 110 may penetrate and drill into formation 112.

As will be appreciated in view of the present disclosure, motor 109 may include any of a number of different components. For instance, motor 109 may include any motor that may be placed downhole, and expressly may include a mud motor, turbine, turbodrill, other motors or pumps, any component thereof, or any combination of the foregoing. A mud motor may include a positive displacement motor (PDM), progressive cavity pump, Moineau pump, other type of motor, or some combination of the foregoing. Such motors or pumps may include a helical or lobed rotor that is rotated by flow of mud 125, and which rotates relative to a stator. The rotor may be coupled to a drive shaft (e.g., shaft 111) which can directly or indirectly be used to rotate drill bit 110. A turbodrill may include one or more turbines or turbine stages that include a set of stator vanes that direct mud 125 against a set of rotor blades. When mud 125 contacts the rotor blades, the rotor may rotate relative to the stator and/or a housing of the turbodrill. The rotor blades may be coupled to a drive shaft (e.g., through compression, mechanical fasteners, etc.), which also rotates and causes shaft 111 and drill bit 110 to rotate.

To provide measurement while drilling capabilities, signals including drilling parameter information may be output from a measurement assembly or tool (e.g., measurement assembly 108) and received at or above the surface by a receiver 123, which may be coupled to controller 122. The signals output from measurement assembly 108 may be conveyed in any number of manners, including through mud pulse telemetry, wired drill pipe, or in other manners. Based on the signals output from measurement assembly 108, controller 122 or a drill operator may vary system parameters (e.g., the flow rate of mud 125) to optimize drilling performance.

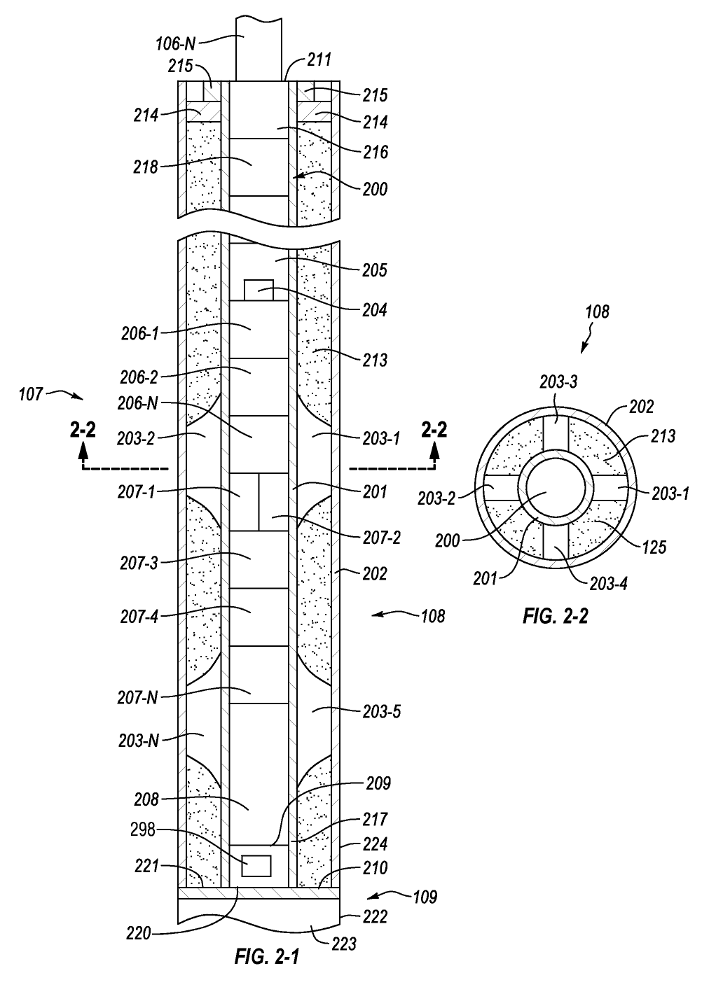

Referring to FIGS. 2-1 and 2-2, cross-sectional, schematic views of an example measurement assembly 108 are shown. In this embodiment, measurement assembly 108 may be what may be referred to as “dumb”, and may have no electronics, sensors, power supplies, or other components therein, and may merely serve as a housing for such components. A dumb drill collar or other measurement assembly 108 may include a MWD tool or sensor string 200 detachably connected to a housing 202 (e.g., a housing of a drill collar). In this embodiment, sensor string 200 may be modular, and may be disconnected from one measurement assembly 108 in the field and connected to another drill collar, drill string, measurement assembly, or the like. Accordingly, a dumb component is different from a so-called “smart” component, in that a smart component includes sensors, electronics, power supplies, or other tools that may be configured to sense and measure different drilling parameters using sensors integrally connected to the drill collar or other component on a permanent basis. The sensors, electronics, power supplies, or other components in a smart component are not intended to be easily removed from one drill collar or other component and placed in another drill collar or other component.

In the measurement assembly 108 shown FIGS. 2-1 and 2-2, sensor string 200 may be fully or partially contained within a sensor string housing 201 and may be placed fully or partially within housing 202. An axis (e.g., a longitudinal axis) of sensor string 200 and/or sensor string housing 201 may align with an axis (e.g., a longitudinal axis) of housing 202. When in alignment, the axis of sensor string 200 or sensor string housing 201 may be co-axial with, or parallel to, the axis of housing 202. In the same or other embodiments, the axis of modular sensor string 200 or sensor string housing 201 may not align with an axis of housing 202. For instance, the axis of modular sensor string 200 or sensor string housing 201 may be at an angle relative to the axis of housing 202. In some embodiments, one or both of the sensor string 200 and measurement assembly 108 may rotate about their respective axes. Thus, the axis of sensor string 200 and the axis of measurement assembly 108 or housing 202 may be a rotational axis.

When assembled to be fully or partially within housing 202, sensor string 200 may be suspended and supported by housing 202 by an upper-hole portion 216 of sensor string 200. Upper-hole portion 216 of sensor string 200 may be coupled to a shelf unit 214 by a sensor string connector 215. Sensor string connector 215 may be fixed to or formed integrally with the outer portion of sensor string housing 201. Sensor string connector 215 may protrude outwardly from the outer surface of sensor string housing 201 and a lower portion of sensor string connector 215 may rest on or be mechanically fastened to an upper surface of shelf unit 214. In some embodiments, shelf unit 214 may be part of (e.g., integral with) or coupled to measurement assembly 108. Shelf unit 214 may be coupled to an inner surface of housing 202, or may protrude inwardly from the inner surface of housing 202. By coupling an upper-hole portion 216 of sensor string 200 to shelf unit 214, a portion of the weight of sensor string 200 may be supported by shelf unit 214 when measurement assembly 108 is placed in a vertically aligned (or mostly vertically aligned) position. Thus, shelf unit 214 may support sensor string 200 in a vertical direction or in a direction parallel to an axis of measurement assembly 108.

Lateral positioning structures 203-1, 203-2, 203-3, 203-4, 203-5 . . . 203-N may act as lateral stabilizers and may be coupled to, or extend from, sensor string housing 201. Lateral positioning structures 203-1 . . . 203-N may be placed in an annular region and extend radially between sensor string housing 201 and housing 202. Lateral positioning structures 203-1 . . . 203-N may be formed from any number of different materials. For instance, one or more of lateral positioning structures 203-1 . . . 203-N may be formed from a polymer-based material, plastic, metal, or any other of various functionally equivalent materials. Lateral positioning structures 203-1 . . . 203-N may provide support to sensor string 200 and position sensor string 200 in a lateral direction or provide radial support in a direction perpendicular to the axis of measurement assembly 108. In some embodiments, lateral positioning structures 203-1 . . . 203-N may centralize sensor string 200 within measurement assembly 108.

As shown in the cross-section view of FIG. 2-2, which is taken at line 2-2 of FIG. 2-1, lateral positioning structures 203-1 . . . 203-N may be positioned between sensor string housing 201 and housing 202 in some embodiments. As illustrated, lateral positioning structures 203-1 . . . 203-N may be arranged radially around the outside perimeter or circumference of sensor string 200 to allow mud 125 to circulate within one or more passageways 213 between lateral positioning structures 203-1 . . . 203-N. Although four lateral positioning structures 203-1 . . . 203-N are shown in the embodiment of FIG. 2-2 and are arranged in a cross-shaped orientation, more or fewer lateral positioning structures may be used in alternative orientations or arrangements. Moreover, while lateral positioning structures 203-1 . . . 203-N may be equally spaced around a circumference of sensor string 200, in other embodiments the spacing may be varied and unequal for one or more of lateral positioning structures 203-1 . . . 203-N.

Sensor string 200 may contain a plurality of sensor units 207-1, 207-2, 207-3, 207-4 . . . 207-N, which sense and provide data regarding any of various drilling parameters. These parameters may be measured in real-time in some embodiments, and may include, but are not limited to, downhole pressure, electrical resistivity, downhole temperature, mud flow volume or mud flow rates, gamma ray density, acceleration of the bottomhole assembly, drill bit, or motor, direction and alignment of the BHA, drill bit, or motor, rotational eccentricity, type and severity of vibration of downhole equipment, torque, and weight-on-bit. Accordingly, in some embodiments, one or more of sensor units 207-1 . . . 207-N (e.g., sensor unit 207-1) may be a pressure sensor. One or more of sensor units 207-1 . . . 207-N (e.g., sensor unit 207-2) may be a temperature sensor. One or more of sensor units 207-1 . . . 207-N (e.g., sensor unit 207-3) may be a gamma ray detector. One or more of sensor units 207-1 . . . 207-N (e.g., sensor unit 207-4) may include accelerometers in one or both of a radial direction and a longitudinal direction. One or more of sensor units 207-1 . . . 207-N (e.g., sensor unit 207-N) may include direction sensors, alignment sensors, vibration sensors, weight sensors, rotational shape sensors, a sensor that measures rotation of a drill collar, other sensors, or any combination of the foregoing.

In the embodiment shown in FIG. 2-1, various sensor units 207-3 . . . 207-N are shown in to be aligned longitudinally and sensor units 207-1 and 207-2 are arranged radially adjacent to each other above sensor units 207-3 . . . 207-N. The arrangement or configuration of the sensor units within the sensor string 200 or within sensor string housing 202 may, however, be varied and is not limited to a particular radial or longitudinal order or arrangement, and sensor units 207-1 . . . 207-N may be arranged in other various positions or arrangements. For instance, in other embodiments, sensor units 207-1 and 207-2 may not be arranged radially adjacent to each other, but rather sensor unit 207-1 may be arranged above sensor unit 207-2, and other sensor units, such as sensor units 207-3 and 207-4 may be arranged radially adjacent to each other. Similarly, in some embodiments, one or more of sensor units 207-3 . . . 207-N may be positioned above one or both of sensor units 207-1 and 207-2.

Sensor units 207-1 . . . 207-N may be powered by any suitable power source. In FIG. 2-1, power may be provided by power packs 206-1, 206-2 . . . 206-N. Power packs 206-1 . . . 206-N may include batteries in some embodiments, although other or additional power sources and power supplies may also be used. Further, in some embodiments, electrical power used to power sensor units 207-1 . . . 207-N may be generated from rotation of the motor 109. Data detected by sensor units 207-1 . . . 207-N may be output by the sensor units 207-1 . . . 207-N, respectively, to a processing unit 218 for data processing and/or analysis. Processed or analyzed data may then be output from processing unit 218 to a communication unit 205, which may include a transmitter 204. In other embodiments, unprocessed and unanalyzed data may be output by sensor units 207-1 . . . 207-N to communication unit 205 and/or transmitter 204. Information regarding drill parameters, whether processed/analyzed by processing unit 218 or unprocessed, may be communicated uphole to a receiver (e.g., receiver 123 of FIG. 1). The information regarding drill parameters may be transmitted uphole to the receiver by electromagnetic telemetry. In the same or other embodiments, mud-pulse telemetry, wired drill pipe communications, fiber optics, or another functionally equivalent communication mechanism may be employed to transmit the information to the receiver. In some embodiments, the data may be transmitted in real-time or in near real-time. Where sufficiently high data transfer rates are possible, the receiver may also receive data in real-time or near real-time. The receiver may be at, above, or near the ground level. Received information regarding drill parameters may be used to optimize well drilling performance and rate of penetration. Processing, analyzing, and calculating of the various drill parameters may be performed downhole by processing unit 218, or may be performed uphole (e.g., by controller 122 of FIG. 1).

In some embodiments, sensor string 200 may include a rotational speed measuring device 209 that provides information regarding downhole rotational speed (e.g., revolutions per minute (RPM), rotations per second, radians per second, etc.) of a downhole component (e.g., motor 109 or shaft 111 of FIG. 1) or the rotational speed of a downhole component relative to the rotational speed measuring device. Rotational speed measuring device 209 may be coupled within the sensor string 200 at a lower-hole portion of sensor string 200, or at some other location. Further, in some embodiments, it may be useful to locate rotational speed measuring device 209 at an end portion of sensor string 200. The end portion where rotational speed measuring device 209 is located may be the end nearest the lower-hole portion 217 of measurement assembly 108, and/or in close proximity to a top portion of motor 109. As shown in FIG. 2-1, a coupling unit 210 may couple the lower-hole portion 217 of measurement assembly 108 to an upper-hole portion 223 of a motor housing 222 of motor 109. In some embodiments, coupling unit 210 may include a threaded connector, a weld, another coupling device, or any combination of the foregoing. Optionally, a bottom edge 220 of rotational speed measuring device 209 may be aligned flush or close to flush with a bottom edge 221 of measurement assembly 108. In some embodiments, the rotational speed measuring device 209 may include processor 298 capable of processing data obtained by the rotational speed measuring device 209 (e.g., accelerometer/vibration data, gyroscope data, Hall Effect sensor data, pressure pulse data, etc.). The data obtained may be rotational speed data or other data used by the processor 298 to calculate or otherwise obtain downhole rotational speed or related data (e.g., RPM, rotations per second, radians per second, angular speed, velocity, or acceleration, etc.) of a downhole component (e.g., the motor 109 or a shaft, such as shaft 111 of FIG. 1).

As shown in FIG. 2-1, a telescoping unit 208 may be provided in some embodiments, and in this particular embodiment telescoping unit 208 is located longitudinally between one or more of sensor units 207-1 . . . 207-N and rotational speed measuring device 209. Telescoping unit 208 may be configured to allow rotational speed measuring device 209, or components thereof, to be placed in a useful, and perhaps optimal or near optimal, sensing position along a length of measurement assembly 108. In at least some embodiments, telescoping unit 208 allows a position of rotational speed measuring device 209 (or components thereof) to be adjusted and moved to different positions along a length of a drill string, bottomhole assembly, measurement assembly, drill collar, or the like.

Although telescoping unit 208 is shown in FIG. 2-1 to be between sensor units 207-1 . . . 207-N and rotational speed measuring device 209, telescoping unit 208 may be placed at other positions or in an alternative order along sensor string 200. Telescoping unit 208, therefore, may not be coupled directly to rotational speed measuring device 209. For example, in another embodiment, telescoping unit 208 may be located longitudinally between sensor string connector 215 and sensor units 207-1 . . . 207-N, or in another embodiment, telescoping unit 208 may be located longitudinally between some of the sensor units 207-1 . . . 207-N (e.g., downhole from sensor units 207-1 and 207-2 but uphole from sensor units 207-3, 207-4, and 207-N). Telescoping unit 208 may be located longitudinally uphole or downhole relative to rotational speed measuring device 209.

Additionally, although the axis of sensor string 200 or telescoping unit 208 may align directly with the axis of housing 202 in the embodiment shown in FIGS. 2-1 and 2-2, in another embodiment, an axis of telescoping unit 208 or of sensor string 200, or portions thereof, may not be aligned with, co-axial with, overlay, or even be parallel to the axis of housing 202. For instance, in another embodiment, an axis of sensor string 200 or telescoping unit 208 may be radially and/or angularly offset from the axis of housing 202. Further, in the example shown in FIG. 2-1, sensor string 200 is shown to include power packs 206-1 . . . 206-N and sensor units 207-1 . . . 207-N encased within, or coupled to, a single sensor string housing 201. In another example embodiment, however, portions of the sensor string 200, power packs 206-1 . . . 206-N, or sensor units 207-1 . . . 207-N may be encased by, or coupled to, different, separate, or multiple sensor string housings.

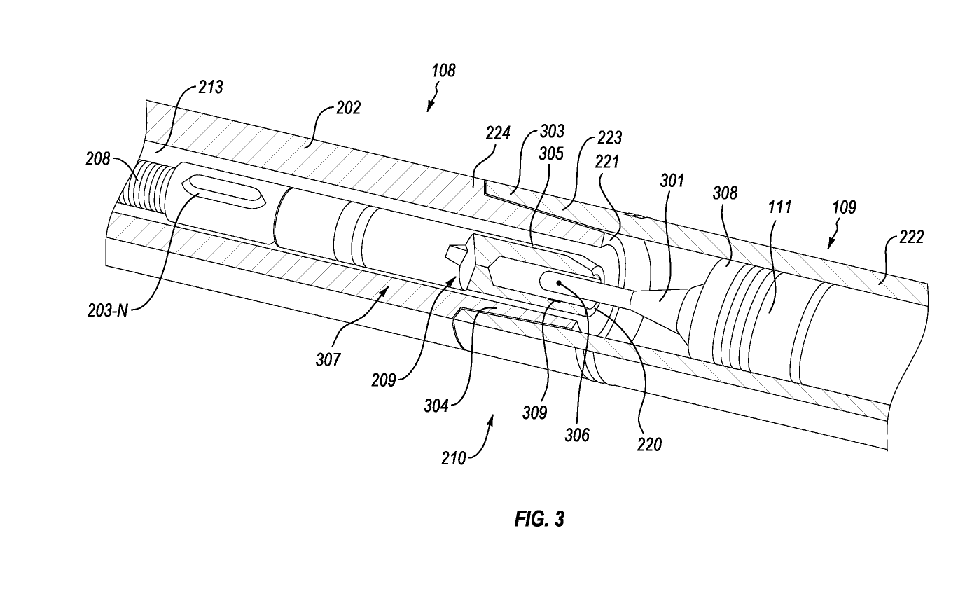

In one example, rotational speed measuring device 209 may include a magnet and a magnetic sensor. In the embodiment shown in FIG. 3, for instance, a rotational speed measuring device 209 may include a magnet 306, which may be included in a magnetic assembly. In one embodiment, the magnetic assembly may include a magnetic finger 301. However, in other embodiments, the magnetic assembly may include other configurations, for example, a cylinder, a disc, or both. In another embodiment, the magnetic assembly may include embedding the magnetic within or coupling the magnetic, either directly or indirectly, to an upper-hole portion of a shaft of the motor. Rotational speed measuring device 209 may also include a magnetic sensor 307. In the embodiment shown in FIG. 3, magnetic finger 301 is coupled to an upper-hole portion 308 of a shaft 111 (e.g., a drive shaft). An axis of magnetic finger 301 may be aligned with, coaxial with, or overlay an axis of shaft 111. Thus, according to the embodiment shown in FIG. 3, magnetic finger 301 may rotate about its longitudinal axis at the same rate and about the same longitudinal axis as shaft 111, and the magnetic finger being aligned along a rotational axis of the motor. A drill bit (e.g., drill bit 110 of FIG. 1) may also share a longitudinal axis with shaft 111 and/or magnetic finger 301. The magnetic sensor 307 may measure the rotational speed of magnetic finger 301, and potentially does so without contact being made between the magnetic sensor 307 the magnetic finger 301, or without contact between a sensor string (e.g., sensor string 200 of FIGS. 2-1 and 2-2) and drill shaft 111. In some embodiments, the magnet 306 may be polarly aligned perpendicular or nearly perpendicular to the axial direction of the housing 202 or magnetic finger 301.

According to the embodiment shown in FIG. 3, magnetic sensor 307 may include a housing or body, which in this embodiment may include a cup-shaped housing 305. In at least some embodiments, the cup-shaped housing 305 may be configured to house or be coupled to a magnetic sensing device 309. In one embodiment, the magnetic sensing device 309 may include a Hall Effect sensor. In another embodiment, the magnetic sensing device 309 may include an inductor or any one of numerous equivalent magnetic transducers or components. Combinations of different types of magnetic sensing devices 309 may also be housed by, or coupled to, cup-shaped housing 305. As shown in FIG. 3, cup-shaped housing 305 may be configured to mate with and at least partially enclose magnetic finger 301, and sense the rate of rotation or rotational speed of magnet 306. For instance, as discussed in additional detail herein, cup-shaped housing 305 may include a port, opening, concavity, or concave feature into which magnetic finger 301 may be positioned. Additionally, as shown in FIG. 3, telescoping unit 208 may be coupled to magnetic sensor 307, and a lateral positioning structure 203-N may maintain the bottom-hole portion of the sensor string (e.g., sensor string 200 of FIGS. 2-1 and 2-2) at a predefined radial position with respect to housing 202.

As described herein, telescoping unit 208 may provide relative positional adjustment between magnet 306 and magnetic sensor 307 along a longitudinal length of housing 202 (i.e., in a direction parallel to the axis of housing 202). By way of non-limiting example, telescoping unit 208 may allow magnetic sensor 307 to be positioned closer to or further away from drill shaft 111. Thus, magnetic sensor 307 may be positioned closer to or further away from magnetic finger 301, and within sensing proximity of electromagnet 306.

As shown in the embodiment of FIG. 3, a bottom edge 220 of rotational speed measuring device 209, or particularly a bottom edge of the cup-shaped housing 305, may be adjusted in a direction parallel to the axis of the housing 202. In some embodiments, such adjustment may allow the bottom edge of the cup-shaped housing 305 to be aligned or flush, or substantially flush, with a bottom edge 221 of measurement assembly 108. Further, according to the embodiment shown in FIG. 3, coupling unit 210 may include a female or box portion 303 formed on upper-hole portion 223 of motor housing 222, and a male or pin portion 304 formed on lower-hole portion 224 of housing 202. Thus, according to the example shown in FIG. 3, in the connected position of measurement assembly 108 and motor 109, box portion 303 of upper-hole portion 223 of motor housing 222 may be configured to threadably engage or otherwise mate with the pin portion 304 of lower-hole portion 224 of housing 202.

As can be seen in the example shown in FIG. 3, the position of magnetic sensor 307 can, in some embodiments, be concentrically contained within measurement assembly 108, such that magnetic sensor 307 does not extend out of lower-hole portion 224 of housing 202. Similarly, the position of magnetic finger 301 can be concentrically contained within motor 109, such that magnetic finger 301 does not extend out of upper-hole portion 223 of motor housing 222. As a result, if measurement assembly 108 and motor 109 are disconnected and separated, magnetic sensor 307, including magnetic sensing device 309, may be protected by housing 202, and magnetic finger 301, including magnet 306, may be protected by motor housing 222. Furthermore, when measurement assembly 108 or housing 202 is mated together with motor 109, or upper portion 223 of motor housing 222, magnetic finger 301 may also mate with cup-shaped housing 305.

Although telescoping unit 208 is described herein as allowing the position of magnetic sensor 307 of rotational speed measuring device 209 to be adjusted relative to magnet 306, telescoping unit 208 may be used in other ways. For instance, in some embodiments, telescoping unit 208 may be connected to a magnet and the adjustment of telescoping unit 208 may adjust the position of the magnet relative to a magnetic sensor, such as a magnetic sensor connected to motor. In other embodiments, telescoping unit 208 may be used to adjust the relative position between two components, regardless of whether the two components are part of a measurement device.

In an example embodiment, and as shown in FIG. 4-1 through FIG. 5, a magnetic finger 301 may include a body 401 defining or otherwise including a receiving space 403 therein. The receiving space 403 may have any suitable form, and as shown in FIG. 4-2, may in some embodiments be or include an elongated channel or void within an interior of body 401. An insert 501 may also be provided and configured to be positioned at least partially within the receiving space 403. In some embodiments, a magnet 502 may be coupled to or otherwise associated with the insert 501. In some embodiments, body 401 may be formed of a non-magnetic metallic material. Similarly, in some embodiments, insert 501 may be formed of a non-magnetic non-metallic material.

When assembled, magnet 502 may be placed within or coupled to the insert 501, and the insert 501 may be screwed into or otherwise placed within receiving space 403 in the body 401. As a result, the magnet 502 may be positioned near an end, or upper-hole portion of the body 401. Magnetic finger 301 may then be coupled to an upper-hole section of a shaft (e.g., shaft 111 of FIG. 3) by a threaded section 402. The illustrated threaded section 402 is shown as a threaded pin section, but in other embodiments the threaded section 402 may include a threaded box section, or the magnetic finger 301 may be coupled to a shaft or other component using some other connecting mechanism.

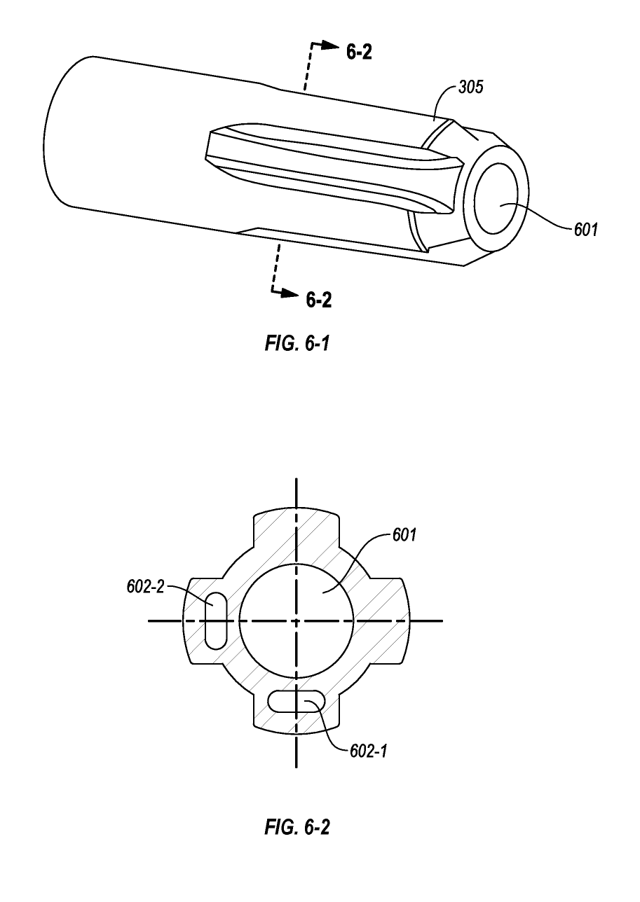

According to some example embodiments, as shown in FIG. 6-1, for instance, the cup-shaped housing 305 of magnetic sensor 307 may include a single component which has an external port 601. The external port 601 may, in some embodiments, include a channel, void, or other opening which can receive or otherwise fully or partially enclose a magnetic finger (e.g., magnetic finger 301 of FIG. 4-1) during mating between various components (e.g., measurement assembly 108 and the motor 109 of FIG. 3). In some embodiments, magnetic sensor 307 may be formed of a metal, alloy, polymer, composite, or other material, or any combination of the foregoing. In at least some embodiments, the magnetic sensor 307 and material(s) used to make the magnetic sensor 307 may be non-magnetic. As shown in FIG. 6-2, which is a cross-sectional view of the cup-shaped housing 305 along lines 6-2 of FIG. 6-1, the cup-shaped housing 305 may define one or more openings or slots 602-1, 602-2. Slots 602-1, 602-2 may extend through at least a portion of the cup-shaped housing 305 and may be radially offset from one another. In these slots, magnetic sensing devices (e.g., magnetic sensing devices 309 of FIG. 3) may be placed, respectively. So arranged, the magnetic sensing devices may measure the rotating magnetic field from the magnetic finger and allow the sensor string to determine the rotational speed (e.g., in revolutions per minute, radians per second, etc.) of the corresponding motor, pump, shaft, or other rotating component.

In some embodiments, slots 602-1, 602-2 may be placed about 90° apart. In other embodiments, slots 602-1, 602-2 may be spaced apart by other selected offsets. For instance, slots 602-1, 602-2 may be placed between 15° and 165° apart in some embodiments. In at least some embodiments, the angular offset between slots 602-1, 602 may be within a range having lower and/or upper values that include any of 15°, 25°, 35°, 45°, 55°, 65°, 70°, 75°, 80°, 85°, 90°, 95°, 100°, 105°, 110°, 115°, 125°, 135°, 145°, 155°, 165°, or any value therebetween. For instance, slots 602-1, 602-2 may be between 75° and 105° apart, between 60° and 100° apart, or between 45° and 145° apart. In other embodiments, slots 602-1, 602-2 may be less than 15° or more than 165° apart. Additionally, FIG. 6-2 illustrates the slots 602-1, 602-2 as being positioned within fins extending radially outward from a central core of cup-shaped housing 305. In the illustrated embodiment, four fins are shown, and slots 602-1, 602-2 are shown in two of the four fins. In other embodiments, each of the fins may include a slot, or a single fin may include a slot. In still other embodiments, the fins may be eliminated and magnetic sensing devices may be positioned in other locations. In still other embodiments, more or fewer than four fins may be included, with any number of such fins including a slot therein.

Additionally, although in some examples a rotational speed measuring device may include a cup-shaped housing and finger structure, rotational speed measuring devices may include other arrangements of magnetic sensing devices for measuring the relative rotation of a magnet in one of various functionally equivalent alternatives. For instance, in another example, a rotational speed measuring device may include a magnet coupled to a drive shaft in an alternative structure or embedded in or coupled to the drive shaft directly. In such an arrangement, a magnetic sensor could sense a rotation of the magnet to obtain information regarding the rotational speed of the drive shaft. In another embodiment, a relationship may be reversed and a magnetic cup-shaped or other housing may be coupled to or included with a drive shaft, motor, or other component. A magnetic sensor could include a finger to be received within the housing to sense rotation of the magnetic housing and obtain information regarding the rotational speed of the drive shaft, motor, or other component.

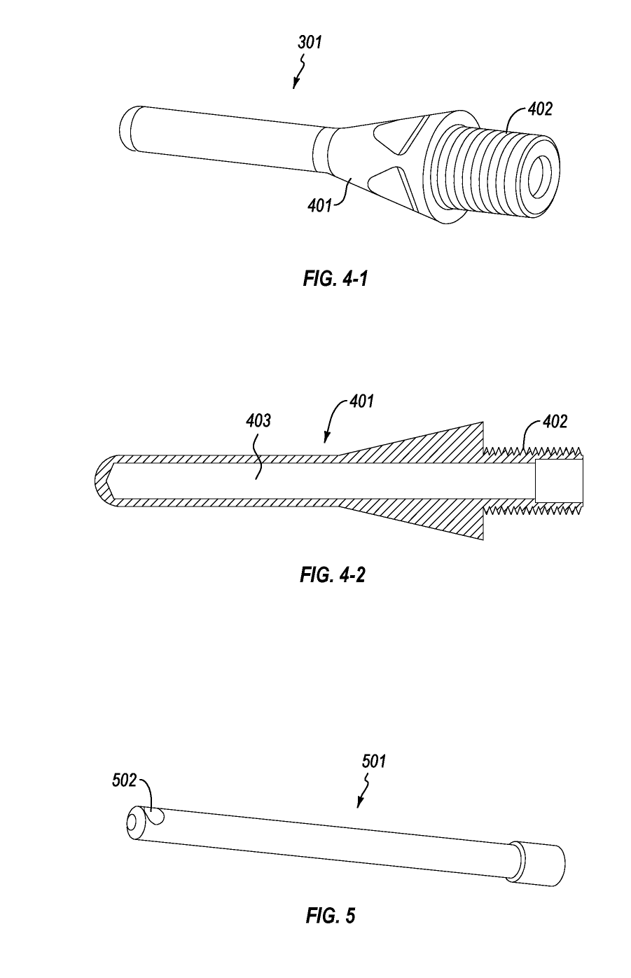

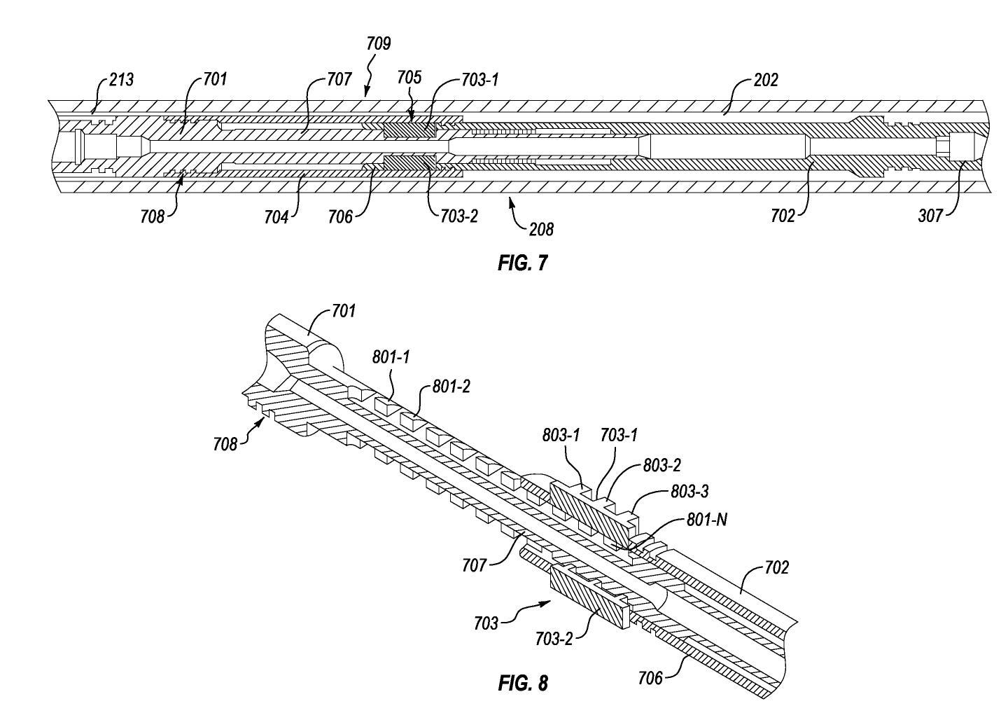

According to some embodiments, as shown in the embodiments of FIGS. 7 and 8, telescoping unit 208 may include an extender base 701 and extender head 702. In some configurations, extender base 701 and extender head 702 may be allowed to move relative to each other. For instance, when unfastened, relative movement between extender base 701 and extender head 702 may be permitted in a direction parallel to the axis of extender base 701 and/or extender head 702. Such movement may be along an elongated or longitudinal length of extender base 701 or extender head 702. In the example shown in FIG. 7, the movement may be parallel to the axis of housing 202. According to the example of FIG. 7, telescoping unit 208 includes a mating section 709, which may include a female or box mating portion 706 of extender head 702 and a male or pin mating portion 707 of extender base 701. The telescoping unit 208 also may include a key 705 that can be selectively inserted and removed to lock or release extender head 702 from extender base 701. When fastened, key 705, which may include key parts 703-1 and 703-2, can restrict and potentially prevent relative rotational and/or axial movement between extender head 702 and extender base 701. In this embodiment, key parts 703-1, 703-2 may oppose each other, or be on opposite sides of telescoping unit 208. In other embodiments, however, key 705 may include parts that are otherwise arranged relative to each other around extender head 702 and 701 without being on opposite side of telescoping unit 208. When key 705 is removed, pin mating portion 407 may be allowed to concentrically engage box mating portion 706, and relative movement between extender base 701 and extender head 702 may be permitted in a direction parallel to the axis of extender base 701 and/or extender head 702. The relative movement between extender base 701 and extender head 702 may permit the accurate relative positioning between magnetic sensor 307 and a magnetic finger (e.g., magnetic finger 306 of FIG. 3). For instance, as alluded to above in connection with FIG. 3, the adjustment of telescoping unit 208 may allow for magnetic sensor 307 to be positioned adjacent to bottom edge 221 of housing 202 so that magnetic finger 301 may be received by or otherwise mate with cup-shaped housing 305 in such a way that magnet 502 (see FIG. 5) and magnetic sensing device 309 are positioned within sensing proximity of one another.

As shown in FIG. 8, each of key parts 703-1, 703-2 may include one or more locking structures 803 (e.g., locking structures 803-1, 803-2, 803-3). When in the locked position, as shown in FIG. 8, locking structures 803-1, 803-2, 803-3 may extend into or penetrate through-holes (not shown) formed in extender head 702, and may engage ridges or other features of any of base ridges 801-1, 801-2 . . . 801-N. Base ridges 801-1 . . . 801-N, which may be separated by a discrete or predetermined interval along a length of telescoping unit 208 (i.e., in a direction parallel to a longitudinal axis of the telescoping unit 208), may protrude in a radially outward direction from pin mating portion 707 of extender base 701. Once engaged with the selected base ridges 801-1 . . . 801-N, locking structures 803-1, 803-2, 803-3 may restrict, and potentially prevent, relative rotational and/or axial movement between extender head 702 and extender base 701.

In accordance with some embodiments, telescoping unit 208 may allow for adjustments to the position of the magnetic sensor or a magnetic finger or other components along an axis of the housing 202 at predefined increments to place the magnetic finger and the magnetic sensor into a sensing proximity of one another. In one embodiment, the increments between base ridges 801-1 . . . 801-N, and thus the adjustment increments between a magnetic sensor, magnetic finger, or other components, may be between ⅛ inch (3.2 mm) and 2 inches (50.8 mm). In at least some embodiments, at least some adjustment increments may be within a range having lower and/or upper values that include any of ⅛ inch (3.2 mm), ¼ inch (6.4 mm), ⅜ inch (9.5 mm), ½ inch (12.7 mm), ⅝ inch (15.9 mm), ¾ inch (19.1 mm), ⅞ inch (22.2 mm), 1 inch (25.4 mm), 1¼ inch (31.8 mm), 1½ inch (38.1 mm), 1¾ inch (44.5 mm), 2 inches (50.8 mm), or any value therebetween. For instance, the adjustment increments may be between ¼ inch (6.4 mm) and ¾ inch (19.1 mm) or between ⅛ inch (3.2 mm) and 1 inch (25.4 mm). In some embodiments, the adjustment increment may be ½ inch (12.7 mm). In other embodiments, the adjustment increment may be larger than 2 inches (50.8 mm) or less than ⅛ inch (3.2 mm). Moreover, while telescoping unit 208 may have equal adjustment increments and spacing between each of the base ridges 801-1 . . . 801-N., other embodiments contemplate the use of different adjustment increments and spacing between various base ridges 801-1 . . . 801-N.

Additionally, the number of available discrete increments and the total length of possible relative travel between extender head 702 and extender base 701 may vary between 1 inch (2.5 cm) and 8 inches (20.3 cm) in some embodiments. In at least some embodiments, the total length of travel may be within a range having lower and/or upper values that include any of 1 inch (2.5 cm), 2 inches (5.1 cm), 3 inches (7.6 cm), 3½ inches (8.9 cm), 4 inches (10.2 cm), 4½ inches (11.4 cm), 5 inches (12.7 cm), 5½ inches (14.0 cm), 6 inches (15.2 cm), 7 inches (17.8 cm), 8 inches (20.3 cm), or any value therebetween. For instance, the total length of travel may be between 3 inches (7.6 cm) and 6 inches (15.2 mm), between 4 inches (10.2 cm) and 5 inches (12.7 cm), or between 2 inches (5.1 cm) and 4½ inches (11.4 cm). In some embodiments, the total length of travel may be 4½ inches (11.4 cm). In another embodiment, the total length of possible relative travel between extender head 702 and extender base 701 may be 5 inches (12.7 cm). In other embodiments, the total length of possible travel or adjustment of telescoping unit 208 may be less than 1 inch (2.5 cm) or greater than 8 inches (20.3 cm). Accordingly, although certain increments and relative travel lengths are disclosed herein, this disclosure is not limited to these increments or travel lengths. Rather, one of ordinary skill in the art would appreciate that various incremental and travel lengths may be implemented.

According to the example of FIG. 7, telescoping unit 208 may further include a sleeve protector 704. In some embodiments, sleeve protector 704 may be or include a cylindrical section that selectively overlies box mating portion 706 of extender head 702 and pin mating portion 707 of extender base 701 and key 705. In a fastened position, sleeve protector 704 may be removably coupled to a connecting portion 708 of extender base 701. Sleeve protector 704 may be removably coupled to connecting portion 708 by helical threads or other connecting mechanisms, such as a fastener or pin, some other mechanism, or some combination of the foregoing.

According to the embodiment of FIG. 7, when placed in the fastened position, sleeve protector 704 may restrict or potentially prevent key parts 703-1, 703-2 from being removed from engagement with base ridges 801-1 . . . 801-N, and optionally depressions, openings, or through-holes (not shown) of extender head 702. To adjust the relative positioning between extender head 702 and extender base 701, sleeve protector 704 may be disconnected from the connecting portion 708 of extender base 701 and moved toward a motor or other component (e.g., motor 109 of FIG. 3) to expose key 705. Key parts 703-1, 703-2 of key 705 may then each be disengaged from base ridges 801-1 . . . 801-N, so as to allow for relative adjustment between extender head 702 and extender base 701. Then, when extender head 702 and extender base 701 are accurately adjusted relative to one another, key parts 703-1, 703-2 of key 705 may be re-engaged with base ridges 801-1 . . . 801-N, and sleeve protector 704 may be placed over key 705 and coupled to connecting portion 708 of extender base 701.

In accordance with some embodiments, adjustment of the telescoping unit 208 may be performed as follows. First, sleeve protector 704 may be unscrewed or otherwise disconnected from extender base 701. Then, upon removal of sleeve protector 704, key parts 703-1, 703-2 may be removed from engagement with base ridges 801-1 . . . 801-N of extender base 701 and, optionally, cavities, depressions, through-holes (not shown) or other features of extender head 702. At this point, extender base 701 and extender head 702 may freely slide or otherwise move relative to one another along a shared longitudinal or other axis thereof. Upon adjustment to the desired length of the telescoping unit 208, key parts 703-1, 703-2 may be re-inserted into base ridges 801 of extender base 701 (and through-holes or other features of extender head 702, if key parts 703-1, 703-2 were previously removed therefrom). Once extender base 701 and extender head 702 are locked in place relative to one another, sleeve protector 704 may be re-attached to extender base 701, which, as noted herein, may restrict and potentially prevent key 702 from disengaging base ridges 801-1 . . . 801-N and through-holes of extender head 702 and allowing extender base 701 and extender head 702 to move relative to one another.

In addition to, or instead of, the key 705, bases ridges 801-1 . . . 801-N, and through-holes of extender head 702, telescoping unit 208 may employ various other mechanisms for providing adjustment (e.g., along a direction parallel to the axis of housing 202). Examples may include, but are not limited to, concentric, mating or telescoping shafts or tubes coupled and fastened by helical screw threads or a pin fastener. Another embodiment may include aligned, parallel shafts that may be coupled together—once adjusted properly—by a fastening unit, which may include a pin or other fastener.

Although a magnetic sensor 307 may be directly coupled to a downhole side of extender head 702, and extender head 702 may be positioned between extender base 701 and magnetic sensor 307, the position of extender head 702 and extender base 701 could be switched, relative to magnetic sensor 307, so that extender base 701 may be positioned between extender head 702 and magnetic sensor 307. Further, although in the embodiment of FIG. 7, magnetic sensor 307 is shown to be directly coupled to extender head 702, in another embodiment, magnetic sensor 307 maybe indirectly coupled to extender head 702 or telescoping unit 208.

Further, in the above examples, including the example embodiment of FIG. 3, rotational speed measuring device 209 may include magnetic finger 301, including magnet 306, coupled to shaft 111 and magnetic sensor 307 coupled to sensor string 200 (see FIG. 2). In other examples, however, the magnetic sensor 307 and magnetic finger 301 may be switched, so that the electromagnetic sensor 307 is coupled to shaft 111 and the magnetic finger 301 is coupled to sensor string 200. In other embodiments, a finger structure including a magnetic sensing device may be coupled to sensor string 200 and a magnet embedded in a cup-shaped housing may be coupled to drill shaft 111.

In the field, housings may vary in length. For example, some housings may vary in length from 29 feet (8.8 m) to 31 feet (9.4 m) in length (or from top to bottom in an upright orientation). The upper-portion of a sensor string may be fixed in position relative to the housing by being coupled to a shelf on an internal surface of the housing. Although the components of the sensor string may be varied to roughly align the bottom portion of the sensor string, or components of the sensor string (e.g., the rotational speed measuring device), in close proximity to the bottom edge of the housing, a telescoping unit coupled to or included within the sensor string may allow for finer adjustment along a length of the housing, and in a direction parallel to the axis of the housing. This may allow more accurate placement of rotational speed measuring devices, particularly a magnetic sensors, relative to the bottom portion of the housing or relative to a magnet associated with the motor, shaft, or other downhole component.

In another embodiment, a bottomhole assembly is described. An example bottomhole assembly may include a motor that rotates a drill bit. The bottomhole assembly may also include a measurement coupled to an uphole side of the drill. The motor may be configured to be powered by hydraulic energy. In at least some embodiments, the measurement assembly may include a drill collar housing a sensor string aligned along an axis of a housing of the drill collar. The sensor string may include multiple sensor devices. Each sensor device may be usable to produce a measurement, and potentially a real-time measurement, of a predefined performance aspect of the motor. The sensor string may include a rotational speed measuring device for measuring a rotational speed of the motor. The measuring device may include a magnet and a magnetic sensor. The magnet may be embedded within a magnetic finger, the magnetic finger being coupled to an uphole side of a shaft of the motor. The magnetic finger may be aligned along a rotational axis of the motor, and the axis of the magnet may be perpendicular to the rotational axis of the drill. The magnetic sensor may include a Hall Effect sensor within a cup-shaped housing, and the cup-shaped housing may mate with the magnetic finger. The bottomhole assembly may also include a telescoping unit coupled to the sensor string within the drill collar. The telescoping unit may be used to adjust a position of the magnetic sensor along an axis of the housing of the drill collar. Adjustments may be made at defined or discrete increments to place the magnetic sensor into a sensing proximity of the magnetic finger. The bottomhole assembly may also include a downhole processing unit that can convert an electrical signal output from the magnetic sensor into rotational speed information. The bottomhole assembly may also include a downhole transmitter to transmit the rotational speed information to an uphole receiver.

Thus, according to the embodiments and examples described herein, a downhole rotational speed measurement tool, system, or assembly as described in the disclosed examples, including a rotational speed measuring device and a telescoping unit, may allow a sensor string, MWD tool, or other measurement assembly or component to more easily accommodate drill collars of varying lengths.

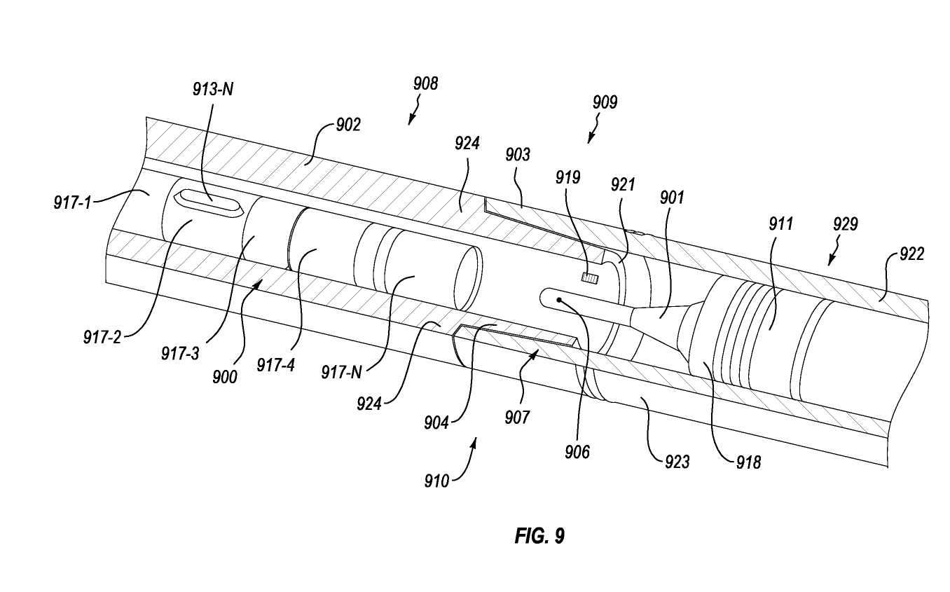

In another embodiment, as shown in FIG. 9, a rotational speed measuring device 909 may include a measurement device, such as magnet 906, which may be included in or attached to a magnetic assembly. In one embodiment, the magnetic assembly may include a magnetic finger 901. Rotational speed measuring device 909 may also include a magnetic sensor 907. In the embodiment shown in FIG. 9, magnetic finger 901 may be coupled to a first or upper portion 918 of a shaft 911 (e.g., a drive shaft). An axis of magnetic finger 901 may be aligned with, parallel to, coaxial with, or overlay an axis of shaft 911. Thus, according to the embodiment shown in FIG. 9, magnetic finger 901 may rotate about its longitudinal axis at the same rate and about the same longitudinal axis as shaft 911, and the magnetic finger 901 may be aligned along a rotational axis of shaft 911. A drill bit (e.g., drill bit 110 of FIG. 1) may also share a longitudinal axis with shaft 911 and/or magnetic finger 901. The magnetic sensor 907 may measure the rotational speed of magnetic finger 901, and potentially may do so without contact being made between magnetic sensor 907 and magnetic finger 901, or without contact between a sensor string 900 (including sensors 917-1, 917-2, 917-3, 917-4 . . . 917-N of sensor string 900) and shaft 911. In some embodiments, magnet 906 may be polarly aligned perpendicular or nearly perpendicular to the axial direction of a housing 902 or magnetic finger 901.

One or more lateral positioning structures, such as lateral positioning structure 913-N shown in FIG. 9, may act as lateral stabilizers and may be coupled to, or extend from, sensor string 900. Although FIG. 9 shows a single lateral positioning structure, a plurality of lateral positioning structures 913-N may be placed in an annular region and may extend radially between sensor string 900 and housing 902. Further, multiple sets of lateral positioning structures may be used to laterally position the sensor string 900 within the housing 902. Lateral positioning structures 913-N may be formed from any number of different materials, for example, but not limited to, a polymer-based material, plastic, metal, or any other of various functionally equivalent materials. Lateral positioning structures 913-N may provide support to sensor string 900 in a lateral direction or provide radial support in a direction perpendicular to the axis of drill collar 908, or some other measurement assembly. In some embodiments, lateral positioning structures 913-N may centralize sensor string 900 within drill collar 908. Lateral positioning structures 913-N may extend radially outward from the sensor string 900 and be located in the annular region between sensor string 900 and housing 902. In some embodiments, the lateral positioning structures 913-N may be arranged radially around the outside perimeter or circumference of sensor string 900 to allow mud to circulate within one or more passageways between each of the lateral positioning structures.

According to the embodiment shown in FIG. 9, magnetic sensor 907 may include at least one magnetic sensing device 919, which may be coupled to an inner surface or inside diameter of housing 902. In other embodiments, magnetic sensing device 919 may be formed within housing 902 or may be fixed within a cavity formed radially within housing 902. In one embodiment, the magnetic sensing device 919 may include a Hall Effect sensor. In another embodiment, the magnetic sensing device 919 may include an inductor or any one of numerous equivalent magnetic transducers or components. Combinations of different types of magnetic sensing devices 919 may also be housed by, coupled to, or formed within housing 902 of a measurement assembly. As shown in FIG. 9, a lower portion 924 of housing 902 may be configured to mate with and potentially at least partially enclose magnetic finger 901, and may sense the rate of rotation or rotational speed of magnet 906. For instance, lower portion 924 of housing 902 may form a port, opening, or concave feature into which magnetic finger 901 may be positioned.

As shown in the embodiment of FIG. 9, a coupling unit 910 may include a female or box portion 903 formed on, or coupled to, upper portion 923 of motor housing 922, and a male or pin portion 904 formed on, or coupled to, lower portion 924 of housing 902. Thus, according to the example shown in FIG. 9, in the connected position of drill collar 908 and motor 929, box portion 903 of upper portion 923 of motor housing 922 may be configured to threadably engage or otherwise mate with the pin portion 904 of lower portion 924 of housing 902. Thus, according to an embodiment, the measurement assembly including magnetic sensor 307 may be configured to receive or mate with the magnetic assembly, which may include magnetic finger 901.

As can be seen in the example shown in FIG. 9, the position of magnetic sensor 907 can, in some embodiments, be contained within and protected by drill collar 908. In some embodiments, protection may be provided by ensuring that magnetic sensor 907 does not extend out of lower portion 924 of housing 902, or in other words, extend below or past a bottom edge 921 of housing 902. Similarly, the position of magnetic finger 901 can be contained within motor 929, such that magnetic finger 901 does not extend above or out of upper portion 923 of motor housing 922. As a result, if drill collar 908 and motor 929 are disconnected and separated, magnetic sensor 907, including magnetic sensing device 919, may be protected by housing 902, and magnetic finger 901, including magnet 906, may be protected by motor housing 922. Furthermore, when the drill collar 908 or housing 902 is mated together with the motor 929, or the upper portion 923 of motor housing 922, the magnetic finger 901 may also mate with the port, opening, concave, cup-shaped, or other feature formed by the inner diameter of the lower-hole portion 924 of housing 902.

In some embodiments, housing 902 may be considered to be part of a “smart” drill collar. That is, magnetic sensing device 919 may be integrally connected to housing 902 in a permanent manner. Housing 902 may also include other sensors, electronics, power supplies, or other components integrated or otherwise secured to housing 902 in a permanent manner.

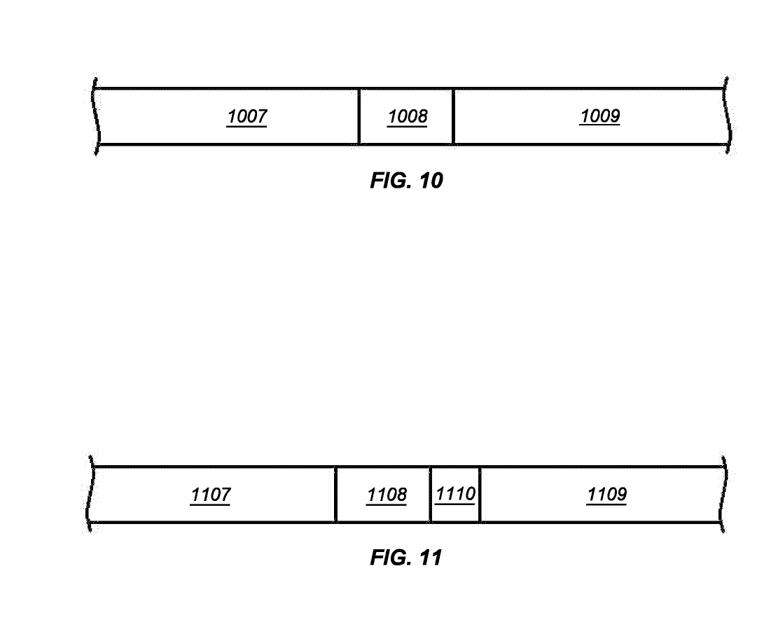

Embodiments of the present disclosure may include downhole drilling and other systems in which tools and components may be modular in nature. FIG. 10, for instance, illustrates an example embodiment of a drilling system in which a bottomhole assembly may include a housing 1007 (e.g., a drill collar housing, a drill pipe, a joint, etc.) coupled to a motor 1009. As discussed herein, the motor 1009 may include a rotating drive shaft. A measurement assembly 1008 may be coupled between the housing 1007 and the motor 1009 to detect rotation of the motor 1009. In some embodiments, the rotation of the motor 1009 may be determined relative to rotation of the housing 1007. More particularly, the motor 1009, or a component thereof, may rotate at a different speed than the housing 1007 which may or may not be rotating.

In accordance with embodiments disclosed herein, the measurement assembly 1008 may include a magnetic tool and a measurement tool. An example magnetic tool may include one or more magnets, magnetic fingers, or the like. An example measurement tool may include a concave or cup-shaped housing, magnetic sensing device, or the like. In some embodiments, the measurement tool may detect the rotational speed of a magnet or magnetic finger.

In a modular configuration, the measurement assembly 1008 may be selectively coupled to the motor 1008 and the housing 1007 using threads, welding, clamps, or any other suitable mechanism. In one embodiment, the magnetic tool of the measurement assembly 1008 may be coupled to or mated with the motor 1008, while the measurement tool of the measurement assembly 1008 may be coupled to or mated with the housing 1007. In another embodiment, the measurement tool of the measurement assembly 1008 may be coupled to or mated with the motor 1008, while the magnetic tool of the measurement assembly 1008 may be coupled to or mated with the housing 1007. Thus, depending on the desired configuration, either a measurement or magnetic tool of the measurement assembly 1008 may be configured to couple to a shaft or rotating component of the motor 1008, with an opposing component being configured to couple to the housing 1007. Although the measurement assembly 1008 is illustrated as a single component in FIG. 10, the measurement assembly 1008 may include multiple, interconnected components. For instance, a magnetic tool and measurement tool may be formed as separate components that may be interconnected to form the measurement assembly 1008. In other embodiments, a telescoping assembly or other component may further be included within the measurement assembly 1008.

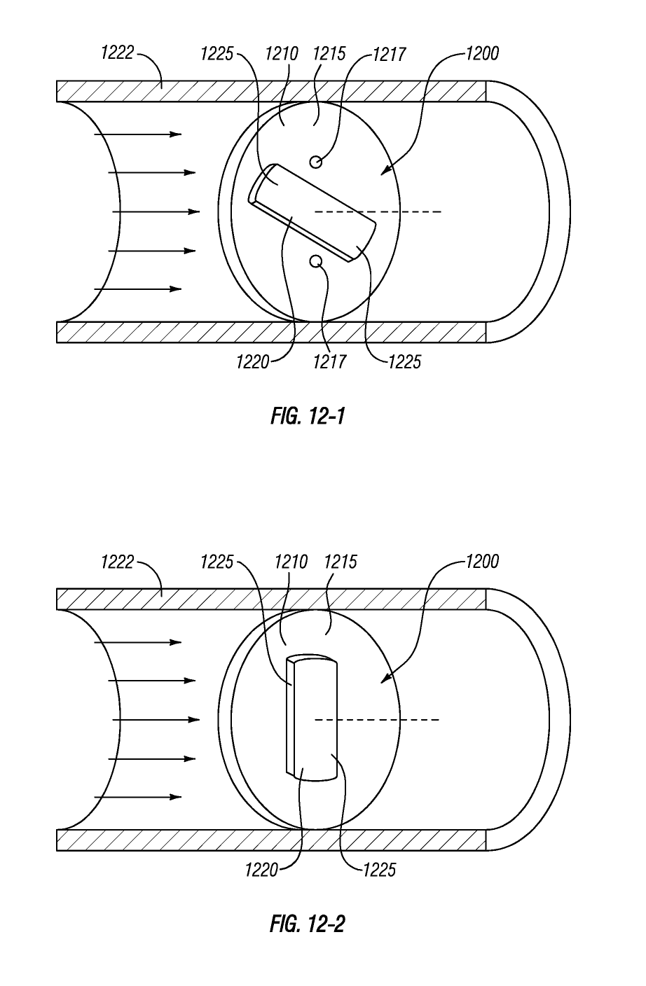

In at least some embodiments, rather than determining the rotational speed of a shaft of a motor, a rotational speed of another component (e.g., a drill pipe, a housing, etc.) may be determined. Thus, the measurement assembly 1008 may also be coupled to the motor 1009 or another suitable component. In at least some embodiments, a measurement assembly may be a universal assembly that may be used to couple to either an internal component (e.g., a motor shaft) or an external component (e.g., a housing). FIG. 11, for instance, illustrates an example embodiment including an uphole housing 1107 coupled to a downhole housing 1109 by a measurement assembly 1108 and a cross-over 1110. The measurement assembly 1108 may be configured to couple to an internal shaft of a motor or other component. The cross-over 1110 may transform a rotation of the external or other component of the housing 1109 into a rotation of an internal component. Optionally, one or more bushings, bearings, or the like may be included within the cross-over 1110 to facilitate conversion of rotation of an external component of the downhole housing 1109 to an internal rotation. The conversion of external to internal rotation may also be coordinated so that each rotate at the same speed. In other embodiments, a gear ratio may be applied to gear up or down the rotation of the internal component relative to the rotation of the downhole housing 1109. The internal component of the cross-over 1110 may be coupled to the measurement assembly 1108. The cross-over 1108 may also operate in the opposite manner, namely by converting an internal rotation into an external rotation. The cross-over 1110 may therefore be coupled between the downhole housing 1109 and the measurement assembly 1108, between the uphole housing 1107 and the measurement assembly 1108, or in both locations. By using one or more cross-overs 1110, the measurement assembly 1108 may be universally used for measuring the rotational speed of downhole components, and cross-overs 1110 can convert different rotations into inputs that can be used by the measurement assembly 1108.

While some embodiments of the present disclosure may use a measurement assembly 1108 which includes a telescoping rotational speed measurement assembly, a finger and housing measurement assembly, gyroscopes, Hall Effect sensors, accelerometers, or other sensors or instrumentation for obtaining rotational speed data or data which can be processed to obtain rotational speed data, any number of different mechanisms may be used. In some embodiments, for instance, a measurement assembly device may use pressure pulses to measure rotational speed.

For example, in at least one embodiment, a rotational speed measuring device or a rotational speed measuring system may include a pressure pulse generator. FIGS. 12-1 and 12-2 illustrate one example of a pressure pulse generator that may be used in a rotational speed measuring device or system. As shown, a pressure pulse generator 1200 may include a stator 1210 and a rotor 1220. The stator 1210 may include a base (shown in FIG. 12-2 as plate 1215) coupled to a housing 1222. The plate 310 may be within and coupled to an inner diameter of the housing 1222. The plate 1215 may include at least one opening, channel, hole, or other orifice 1217 formed therein. As shown in the example of FIG. 12-1, the stator 1210 may include two orifices 1217 in the plate 1215, and spaced 180° apart relative to a longitudinal axis passing through the stator 1210. In other embodiments, more or fewer orifices 1217 may be used, and/or the spacing of the orifices 1217 may be modified. Further, the orifices 1217 may be adjacent peripheral edges of the plate 1215 in some embodiments.

The rotor 1220 may include one or more blades 1225. In at least one embodiment, the blades 1225 may be formed on opposite sides of a rotational axis of the rotor 1220 (e.g., 180° apart). In FIGS. 12-1 and 12-2, the rotational axis of the rotor 1220 is shown by a broken line. The rotor 1220 may be positioned adjacent to or near the stator 1210.

In some embodiments, the rotor 1220 may be connected to a motor (e.g., motor 109 of FIG. 1 or FIG. 2-1) or a component thereof (e.g., shaft 111 of FIG. 1) or to a bit (e.g., drill bit 110 of FIG. 1) such that the rotation of rotor 1220 is coupled to the rotation of the motor or component thereof or to the bit. According to such embodiments, the rotational speed of the rotor 1220 may correspond to the rotational speed of the motor, component thereof, or the bit. In other embodiments, the rotor 1220 may be coupled to another motor that may be powered by the same pump that pumps fluid to a motor that causes a bit to rotate. According to one or more embodiments, the rotational speed of the rotor 1220 may correspond to the rotational speed of the motor that powers the drill bit.

The drilling fluid or mud may pass through the orifices 1217 when the pressure pulse generator 1200 is in an “open” position, as shown in FIG. 12-1. A direction of travel of the drilling fluid or mud is shown by the arrows in FIGS. 12-1 and 12-2. The pressure pulse generator 1200 may be in the open position when the orifices 1217 are not covered or blocked by the blades 1225 of the rotor 1220. In the open position, the blades 1225 may not align with, or otherwise correspond to, the orifices 1217, and the flow of drilling fluid or mud may be maximized. As the rotor 1220 rotates about its rotational axis, the blades 1225 may partially block or entirely cover the orifices 1217, as shown in the “closed” position in FIG. 12-2. In the closed position, the blades 1225 may restrict or even prevent the flow of drilling fluid or mud through orifices 1217. In the closed position, the blades 1225 may align with the orifices 1217, and the flow of drilling fluid or mud through the orifices 1217 may be restricted and/or minimized. In some embodiments, some flow of drilling fluid or mud may continue as the drilling fluid or mud may be used as a hydraulic energy source and may be converted to mechanical energy to power rotation of a motor, bit, or other component. Further, the drilling fluid or mud may cool or lubricate the motor or bit, flush cuttings away from a bit, or be used for other purposes. As the rotor 1220 rotates and the orifices 1217 alternately or cyclically move between the open and closed positions, pressure pulses may be generated within the central bore or drilling fluid column of the drill string. The pressure of the drilling fluid or mud may thus rise or fall at a rate corresponding to the rate of rotation of the rotor 1220.

Although in the embodiment shown in FIGS. 12-1 and 12-2, the orifices 1217 are shown to have a circular cross-section, in other embodiments the orifices 1217 may have a cross-section of different shapes or configurations. For example, orifices of a pressure pulse generator may be triangular, rectangular, elliptical, or asymmetric in cross-section. Additionally, although two orifices 1217 are shown in the embodiment of FIGS. 12-1 and 12-2 as formed in opposite portions of the plate 1215 relative to an axis of the stator 1210, in other embodiments, one or a plurality of orifices may be formed in a plate of the stator in other configurations. For example a single orifice may be formed in the plate of the stator. In other embodiments, three or more orifices may be formed in the plate of the stator. Further, orifices may be formed in a symmetric or asymmetric pattern in the plate.

Additionally, although the rotor 1220 of the embodiment shown in FIGS. 12-1 and 12-2 may be generally rectangular, in other embodiments the rotor may have other shapes or configurations. For example, the rotor may be cross-shaped, with four blades or extremities distributed evenly at 90° intervals about a rotational axis of the rotor. In another embodiment, the rotor may be circular and have passageways formed therein, the passageways corresponding in position to orifices of the stator. In yet another embodiment, a rotor may triangular, star-shaped, or include any number of blades spaced about the rotational axis of the rotor. In some embodiments, the blades of the rotor may correspond in position with the orifices of the stator.

In some embodiments, a pressure pulse generator may be located uphole from a modular sensor string that includes a pressure sensor. In another embodiment, a pressure pulse generator may be positioned downhole from a modular sensor string that includes a pressure sensor. Further, in at least one embodiment, a pressure pulse generator may be positioned within a drill collar housing or a housing of a measurement assembly. In another embodiment, a pressure pulse generator may be positioned within a drill string at a position above a drill collar, a drill collar housing, or a measurement assembly. In yet another example, a pressure pulse generator may be positioned within a drill string at a position below a drill collar, a drill collar housing, or a measurement assembly. In one embodiment, a pressure pulse generator may be positioned within a motor or within a housing of a motor. In another embodiment, a pressure pulse generator may be positioned below a motor or below a housing of a motor.

According to some embodiments of the present disclosure, a pressure sensor may be able to detect and measure pressure pulses produced directly by operation of a motor that rotates a bit. For example, in one embodiment, the motor may be a turbodrill or a mud motor, and the pressure sensor may sense pressure pulses produced within the drilling fluid or mud by operation of the turbodrill or mud motor. A processor may process pressure pulse data output by the pressure sensor, such as by filtering the pressure pulse data to remove noise and/or using an algorithm to obtain rotational speed data of the turbodrill. In another embodiment, the motor may be a mud motor that produces pressure pulses detectable by a pressure sensor. The rotational speed measurement device may then output rotational speed data based on pressure pulse data received from drilling fluid passing through the mud motor.

In some embodiments, the rotational speed measuring device may include a processor (e.g., processor 298 of FIG. 2-1) capable of processing pressure pulse data output from the pressure sensor to produce rotational speed data. The rotational speed data may include information regarding downhole rotational speed of a rotating downhole component. Optionally, the rotational speed of the rotating downhole component corresponds directly or through a ratio to the pressure pulse rate or the rotational speed of a downhole component relative to the rotational speed measuring device. The processor may include processing electronics. The processing of the pressure pulse data by the processor may include filtering the pressure pulse data. The filtering may include performing a low-pass filter to remove noise, such as noise produced by the drill rig pump, noise due to vibrations of the drill string against a wellbore wall or casing, or the like. The filtering may also include removing other forms of noise produced by other vibrations within the drilling system or formation. The processor, either before or after filtering the pressure pulse data, may use an algorithm, such as a digital signal processing algorithm, to process the pressure pulse data over a specified sample period. In one embodiment, a fast Fourier transform (FFT) may be used to process the data.

After processing the data, rotational speed data output by the processor may be sent to a communication unit (e.g., communication unit 205 of FIG. 2-1) and/or a transmitter (e.g., transmitter 204 of FIG. 2-1) for uphole transmission of the rotational speed data to a receiver (e.g., receiver 123 of FIG. 1). The rotational speed data may be transmitted uphole to the receiver by electromagnetic telemetry. In other embodiments, mud-pulse telemetry, wired drill pipe communications, fiber optics, or another functionally equivalent communication mechanism may be employed to transmit the rotational speed data to the receiver. In some embodiments, the rotational speed data may be transmitted in real-time or in near real-time. The receiver may also receive the rotational speed data in real-time or near real-time. The receiver may be at, above, or near the ground level. Received rotational speed data may be displayed on a display on a control panel viewable by drill operator. The rotational speed data may be used to optimize well drilling, milling, underreamer, or other downhole operation performance and/or rate of penetration. In some embodiments, the rotational speed data may be stored downhole in a memory mode rather than communicated uphole to the receiver.

In some embodiments, in addition to, or instead of, processing the pressure pulse data with a processor of the rotational speed measuring device, the pressure pulse data may be input into and analyzed by another downhole or uphole processor (e.g., processing unit 218 of FIG. 2-1), which may process other data detected by one or more sensor units. The data processed by a downhole processing unit may be transmitted uphole by a transmitter, and unprocessed data may be transmitted to an uphole processor by the transmitter.

In some embodiments, a rotational speed measuring device (e.g., device 209) may be a pressure sensor. Example pressure sensors may include piezoelectric pressure transducers. In other embodiments, a pressure sensor may include an electromagnetic pressure sensor, an optical pressure sensor, a capacitive pressure sensor, a resonant pressure sensor, a thermal pressure sensor, a potentiometric sensor, an ionization pressure sensor, or any combination of the foregoing. Although various examples of pressure sensors have been described herein, pressure sensors are not limited to these examples, and those skilled in the art will readily appreciate, with the benefit of the present disclosure, that a pressure sensor used in a rotational speed measuring device may include other types of pressure sensors or a pressure transducer operating under different mechanisms.

In some embodiments, a rotational speed measurement system includes a modular sensor string removably coupled to a measurement assembly. The modular sensor string may include a pressure pulse sensor and a processor. The pressure pulse sensor may be configured to detect pressure pulses corresponding to a rotational speed of a motor, and the processor may be configured to determine rotational speed data based on pressure pulse data output from the pressure pulse sensor. A transmitter of the system may be configured to transmit rotational speed data to a remote receiver.

In some embodiments, a motor may include a downhole motor, such as a turbodrill or a mud motor. The processor may be downhole or uphole while determining rotational speed data. In some embodiments, a measurement assembly includes a drill collar coupled to a motor. The drill collar may include a drill collar housing, and a modular sensor string may be concentrically contained within the drill collar housing. The drill collar may be a dumb drill collar.

In some embodiments, a transmitter may transmit rotational speed data to a remote, uphole receiver by electromagnetic telemetry. A processor and transmitter may be positioned downhole within a wellbore, and a receiver may be at a surface of the wellbore. In some embodiments, an uphole portion of a modular sensor string may be coupled to a shelf unit of a measurement assembly, and the shelf unit may support at least a portion of a weight of the modular sensor string.

According to some embodiments, a rotational speed measurement system may include a pressure pulse generator. The pressure pulse generator may generate pressure pulses at a rate corresponding to the rotational speed of a motor, drill string, bit, or other downhole component. A pressure pulse generator may include a stator and a rotor. The rotor may rotate relative to the stator (or vice versa). In some embodiments, the rotor and stator may be within the motor. The motor may be configured to generate pressure pulses.

In at least some embodiments, a processor is configured to determine rotational speed data within a modular sensor string using a digital signal processing algorithm. The processor may process pressure pulse data through a low-pass filter, using a fast Fourier transform over a sample period, using other techniques, or using any combination of the foregoing.

According to some embodiments, a method for measuring downhole rotational speed includes generating pressure pulses downhole at a rate corresponding to a rotational speed of a downhole motor, detecting the pressure pulses downhole with a modular sensor string, using the detected pressure pulses to generate rotational speed data downhole, and transmitting the rotational speed data uphole.

In at least some embodiments, a bottomhole assembly includes a motor, a measurement assembly, and a modular sensor string within the measurement assembly. The modular sensor string may include a pressure pulse sensor configured to detect pressure pulses, and a processor. The processor may be coupled to the pressure pulse sensor and configured to use pressure pulse data output by the pressure pulse sensor to determine a rotational speed of the motor. A transmitter may be coupled to the processor and configured to transmit rotational speed data to a remote receiver. The optional transmitter may be included within the modular sensor string. A modular sensor string may also be within a drill collar of a measurement assembly.

As discussed herein, some components of some embodiments of the present disclosure may include magnets or magnetic materials. It should be appreciated in view of the disclosure herein that such magnets may include any number of different types of magnets, and may include, electromagnets, permanent magnets, dipole magnets, rare earth magnets, split magnets, or other magnets. In the case of electromagnets, a power pack or other power supply may be used to provide an electric current to create a magnetic field. In other embodiments, however, the material make-up of a magnet (e.g., a permanent magnet or rare-earth magnet) may inherently provide a magnetic field.

Certain terms are used throughout the following description and claims to refer to particular features or components. As those having ordinary skill in the art will appreciate, different persons may refer to the same feature or component by different names. This document does not intend to distinguish between components or features that differ in name but not function. The figures may be to scale for some but not each embodiment contemplated as within the scope of the present disclosure. Certain features and components herein may be shown exaggerated in scale or in somewhat schematic form and some details of conventional elements may not be shown or described in interest of clarity and conciseness.

In the following discussion and in the claims, the terms “including” and “comprising” are used in an open-ended fashion, and thus should be interpreted to mean “including, but not limited to . . . .” Also, the terms “couple,” “coupled,” “couples,” and the like are intended to mean either an indirect or direct connection. Thus, if a first component is coupled to a second component, that connection may be through a direct connection, or through an indirect connection via other components, devices, and connections. Further, the terms “axial” and “axially” mean generally along or parallel to a central or longitudinal axis, while the terms “radial” and “radially” mean generally perpendicular to a central or longitudinal axis.

Additionally, directional terms, such as “above,” “below,” “upper,” “lower,” etc., are used for convenience in referring to the accompanying drawings. In general, “above,” “upper,” “upward,” and similar terms refer to a direction toward the earth's surface from below the surface along a wellbore, and “below,” “lower,” “downward,” and similar terms refer to a direction away from the earth's surface along the wellbore, i.e., into the wellbore, but are meant for illustrative purposes, and the terms are not meant to limit the disclosure. For example, a component of a BHA that is “below” another component may be more downhole while within a vertical wellbore, but may have a different orientation during assembly, when removed from the wellbore, or in a deviated borehole. Accordingly, relational descriptions are intended solely for convenience in facilitating reference to various components, but such relational aspects may be reversed, flipped, rotated, moved in space, placed in a diagonal orientation or position, placed horizontally or vertically, or similarly modified. Relational terms may also be used to differentiate between similar components; however, descriptions may also refer to certain components or elements using designations such as “first,” “second,” “third,” and the like. Such language is also provided merely for differentiation purposes, and is not intended to limit a component to a singular designation. As such, a component referenced in the specification as the “first” component may for some but not each embodiment be the same component that is referenced in the claims as a “first” component.

Furthermore, to the extent the description or claims refer to “an additional” or “other” element, feature, aspect, component, or the like, it does not preclude there being a single element, or more than one, of the additional elements. Where the claims or description refer to “a” or “an” element, such reference is not be construed that there is just one of that element, but is instead to be inclusive of other components and understood as “one or more” of the element. It is to be understood that where the specification states that a component, feature, structure, function, or characteristic “may,” “might,” “can,” or “could” be included, that particular component, feature, structure, or characteristic is provided in some embodiments, but is optional for other embodiments of the present disclosure. The terms “couple,” “coupled,” “connect,” “connection,” “connected,” “in connection with,” and “connecting” refer to “in direct connection with,” “integral with,” or “in connection with via one or more intermediate elements or members.”

Although various example embodiments have been described in detail herein, those skilled in the art will readily appreciate in view of the present disclosure that many modifications are possible in the example embodiments without materially departing from the present disclosure. Accordingly, any such modifications are intended to be included in the scope of this disclosure. Likewise, while the disclosure herein contains many specifics, these specifics should not be construed as limiting the scope of the disclosure or of any of the appended claims, but merely as providing information pertinent to one or more specific embodiments that may fall within the scope of the disclosure and the appended claims. Any described features from the various embodiments disclosed may be employed in combination. In addition, other embodiments of the present disclosure may also be devised which lie within the scopes of the disclosure and the appended claims. Each addition, deletion, and modification to the embodiments that falls within the meaning and scope of the claims is to be embraced by the claims.

Although a few example embodiments have been described in detail herein, those skilled in the art will readily appreciate that many modifications are possible to the example embodiments without materially departing from this disclosure. Accordingly, any such modifications are intended to be included within the scope of this disclosure. In the claims, means-plus-function clauses are intended to cover the structures described herein as performing the recited function, including both structural equivalents and equivalent structures. It is the express intention of the applicant not to invoke means-plus-function or other functional interpretation, except for those in which the claim expressly uses the words “means for” together with an associated function.

Certain embodiments and features may have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges may appear in one or more claims below. Any numerical value is “about” or “approximately” the indicated value, and takes into account experimental error and variations that would be expected by a person having ordinary skill in the art.

Certain embodiments and features may have been described using a set of numerical values that may provide lower and upper limits. It should be appreciated that ranges including the combination of any two values are contemplated unless otherwise indicated, and that a particular value may be defined by a range having the same lower and upper limit. Any numbers, percentages, ratios, measurements, or other values stated herein are intended to include the stated value as well as other values that are about or approximately the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least experimental error and variations that would be expected by a person having ordinary skill in the art, as well as the variation to be expected in a suitable manufacturing or production process. A value that is about or approximately the stated value and is therefore encompassed by the stated value may further include values that are within 5%, within 1%, within 0.1%, or within 0.01% of a stated value.

The Abstract at the end of this disclosure is provided to allow the reader to quickly ascertain the general nature of some embodiments of the present disclosure. It is submitted with the understanding that it will not be used to interpret or limit the scope or meaning of the claims.

What is claimed is:

1. A rotational speed measurement system comprising:
a rotational speed measuring device configured to measure a rotational speed, the rotational speed measuring device including a magnet and a magnetic sensor; and
a telescoping unit configured to position the magnetic sensor into a sensing proximity of the magnet.

2. The system of claim 1, wherein the rotational speed measuring device is coupled to a downhole motor and the rotational speed measuring device is configured to measure the rotational speed of the motor downhole.

3. The system of claim 2, wherein the downhole motor is a turbodrill or a mud motor.

4. The system of claim 1, wherein the rotational speed measuring device includes a magnetic finger, the magnetic finger including the magnet.

5. The system of claim 4, wherein the magnetic sensor includes a cup-shaped housing having a concavity configured to receive the magnetic finger.

6. The system of claim 4, wherein the magnetic sensor is configured to measure a rotational speed of the magnetic finger without contact between the magnetic sensor and the magnetic finger or without contact between the magnetic sensor and a shaft of a motor.

7. The system of claim 1, wherein the magnetic sensor includes a Hall Effect sensor.

8. The system of claim 1, wherein:
the rotational speed measuring device and telescoping unit are located within a housing of a drill collar; and
a first portion of the telescoping unit is configured to remain in a fixed position relative to the housing of the drill collar and a second portion of the telescoping unit is configured to adjustably travel relative to the housing of the drill collar to adjust a position of the magnetic sensor in predefined increments in a direction parallel to a longitudinal axis of the housing of the drill collar.

9. The system of claim 8, further comprising:
a modular sensor string within the housing of the drill collar.

10. The system of claim 1, wherein the telescoping unit includes:
an extender base;
an extender head telescopically associated with the extender base, the extender head and the extender base being configured for movement relative to one another along an axis of the telescoping unit to selectively adjust a length of the telescoping unit;
a key configured to selectively lock the extender head and the extender base together at a plurality of predetermined discrete positions; and
a sleeve protector configured to selectively maintain the key in a locked position.

11. The system of claim 10, wherein the sleeve protector is threadably coupled to the extender base.

12. The system of claim 10, wherein the extender head is located between the extender base and the magnetic sensor.

13. The system of claim 1, wherein the magnet is embedded in a non-magnetic insert of a magnetic finger, the magnetic finger being coupled to an uphole portion of a shaft of a motor.

14. The system of claim 13, wherein a polar axis of the magnet is perpendicular to a rotational axis of the shaft.

15. The system of claim 13, wherein:
the magnetic finger is concentrically contained within an upper end portion of a housing of the motor without extending axially past an upper edge of the housing of the motor, and
the magnetic sensor is concentrically contained within a downhole end portion of a housing of a drill collar without extending axially past a lower edge of the housing of the drill collar.

16. The system of claim 15, wherein the magnetic sensor includes a cup-shaped housing having an external port configured to receive the magnetic finger, and the uphole end portion of the housing of the motor is configured to receive the downhole end portion of the housing of the drill collar while the magnetic finger is mated within the cup-shaped housing.

17. The system of claim 1, further comprising:
a downhole processing unit configured to convert an electrical signal output from the magnetic sensor into rotational speed information; and
a transmitter configured to transmit the rotational speed information to an uphole receiver.

18. The system of claim 17, wherein the transmitter is configured to transmit the rotational speed information to an uphole receiver by electromagnetic telemetry.

19. A rotational speed measurement system comprising:
a rotational speed measuring device configured to measure a rotational speed of a motor, the rotational speed measuring device including:
a magnet coupled by a magnetic assembly to a shaft of the motor, and a magnetic sensor coupled to or included in an inside diameter of a measurement assembly, the measurement assembly being configured to receive the magnetic assembly; or
a pressure pulse generator.

20. A method for measuring downhole rotational speed, comprising:
coupling a rotational speed measuring device to a measurement assembly and a downhole component, the rotational speed measuring device including a magnet and a magnetic sensor; and
adjusting with a telescoping unit a position of at least one of the magnetic sensor or the magnet to place the magnetic sensor into sensing proximity of the magnet.
